(19) United States
(12) Patent Application Publication
(10) Pub. No.: US 2025/0330866 A1
(43) Pub. Date: Oct. 23, 2025

(54) SCS QOS CHARACTERISTICS OPERATION FOR DYNAMIC QOS

(71) Applicant: Cisco Technology, Inc., San Jose, CA (US)

(72) Inventors: Malcolm M. SMITH, Richardson, TX (US); Brian D. HART, Sunnyvale, CA (US); Binita GUPTA, San Diego, CA (US)

(21) Appl. No.: 19/182,060

(22) Filed: Apr. 17, 2025

Related U.S. Application Data
(60) Provisional application No. 63/635,213, filed on Apr. 17, 2024.

(51) Int. Cl. H04W 28/02; H04W 28/24; H04W 74/0816; H04W 84/12

(52) U.S. Cl. CPC H04W 28/0268; H04W 28/24; H04W 74/0816; H04W 84/12

(57) ABSTRACT

SCS negotiation can be used to establish different QoS profiles for a network flow. However, switching between tiers and/or profiles using SCS messages (which are typically management frames) is time consuming. SCS messages are typically processed in the host processor (e.g., a host central processing unit (CPU)) in the AP. Instead, the embodiments herein discuss signaling schemes to quickly switch between quality tiers or QoS profiles using data or control frames.

### CROSS-REFERENCE TO RELATED APPLICATIONS

This application claims benefit of co-pending U.S. provisional patent application Ser. No. 63/635,213 filed Apr. 17, 2024. The aforementioned related patent application is herein incorporated by reference in its entirety.

### TECHNICAL FIELD

Embodiments presented in this disclosure generally relate to wireless communication. More specifically, one or more embodiments disclosed herein relate to quality of service (QoS) for wireless communication.

### BACKGROUND

The stream classification service (SCS) protocol includes a QoS characteristics element, which supports a single level of QoS for an SCS flow. But for modern applications (e.g., streaming video, video conferencing, augmented reality (AR) and virtual reality (VR) applications, and a wide variety of other applications), a single level of QoS is likely to be insufficient. For example, an application may support different quality tiers (e.g., different resolutions, color depths, frame rates, audio codecs, or other characteristics), particularly in response to congestion over the network. Existing SCS techniques do not support signaling of multiple QoS tiers for the same flow, and this makes it difficult for the network (e.g., a wireless access point (AP)) to balance the needs of its different flows (e.g., from different wireless stations (STAs)).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a wireless network where a STA (or AP) can change between QoS profiles, according to one embodiment.

FIG. 2 is a flowchart for determining whether a STA can change between QoS profiles, according to one embodiment.

FIG. 3 is a flowchart for using priority to determine whether to honor a request to switch between QoS profiles, according to one embodiment.

FIG. 4 is a flowchart for an AP to change QoS profiles, according to one embodiment.

FIG. 5 is a flowchart for pausing or suspending a QoS profile, according to one embodiment.

FIG. 6 is a flowchart illustrating proposing QoS characteristics for a flow as part of stream classification with multiple quality tiers, according to one embodiment.

FIG. 7 is a flowchart further illustrating proposing QoS characteristics for a flow as part of stream classification with multiple quality tiers, according to one embodiment.

FIG. 8 is a flowchart illustrating establishing QoS characteristics for a flow as part of stream classification with multiple quality tiers, according to one embodiment.

FIG. 9 is a flowchart further illustrating establishing QoS characteristics for a flow as part of stream classification with multiple quality tiers, according to one embodiment.

FIG. 10 illustrates a STA and AP, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes establishing multiple quality of service (QoS) profiles or quality tiers for a wireless device using a Stream Classification Service (SCS) negotiation between the wireless device and an access point (AP) and receiving a request, in a data frame, a control frame, or a non-Frame body portion of a management frame, from the wireless device at the AP to switch from a first profile or tier of the established multiple QoS profiles or quality tiers to a second profile or tier of the established multiple QoS profiles or quality tiers/

Another embodiment presented in this disclosure is a network device that includes one or more memories and one or more processors communicatively coupled to the one or more memories. The one or more processors are configured to, individually or collectively, perform operations that include establishing multiple quality of service (QoS) profiles or quality tiers for a wireless device using a Stream Classification Service (SCS) negotiation between the wireless device and the network device and receiving a request, in a data frame, a control frame, or a non-Frame body portion of a management frame, from the wireless device to switch from a first profile or tier of the established multiple QoS profiles or quality tiers to a second profile or tier of the established multiple QoS profiles or quality tiers.

Another embodiment presented in this disclosure is an AP that includes one or more memories and one or more processors communicatively coupled to the one or more memories. The one or more processors are configured to, individually or collectively, perform operations that include providing multiple quality of service (QoS) profiles or quality tiers for a wireless device using a Stream Classification Service (SCS) negotiation and receiving a request, in a data frame, a control frame, or a non-Frame body portion of a management frame, from the wireless device at the AP to switch from a first profile or tier of the established multiple QoS profiles or quality tiers to a second profile or tier of the established multiple QoS profiles or quality tiers.

### Example Embodiments

One or more embodiments disclosed herein extend SCS to allow for multiple quality tiers for STAs. For example, STAs can signal the existence of multiple quality tiers, and the required QoS (e.g., SCS-level parameters such as minimum data rate, service internal, delay bound loss rate, and other suitable parameters) for each tier. An AP can then dynamically switch QoS, as necessary or available, based on the allowed quality tiers. Further, in one embodiment, an STA can register multiple QoS profiles, allowing an AP to switch among profiles as necessary (e.g., based on network congestion), and the STA can dynamically indicate that an AP should switch profiles.

However, switching between tiers and/or profiles using SCS messages (which are typically management frames) is time consuming. SCS messages are typically processed in the host processor (e.g., a host central processing unit (CPU)) in the AP. Instead, the embodiments herein discuss signaling schemes to quickly switch between quality tiers or QoS profiles using a wireless chipset (e.g., a Wi-Fi chipset) which does not involve the host processor in the AP. For example, when wanting to switch between tiers or profiles, a STA can transmit a SCS identifier (ID) and QoS profile ID in a data frame (e.g., a MAC header in a data frame) or a control frame which is processed by the wireless chipset in the AP. This chipset can determine to switch to the new profile/tier in the next transit opportunity (TXOP) without having to rely on the host processor, thereby enabling much faster tier and profile switching when compared to using SCS signaling which are processed by the host processor in the AP. Additionally, the SCSID and QoS profile ID can be transmitted a non-Frame body portion of a management frame, unlike typical SCS management frames. Like data frames, a management frame can include an A-Control field which can include the SCSID and QoS profile ID in a non-Frame body portion of the frame, although the management frame may be processed slower than a data or control frame.

These embodiments have numerous technical advantages. For example, knowing in advance the various quality tiers or QoS profiles (e.g., to support varying resolutions of streaming video) can allow an AP to proactively reserve resources (e.g., virtual resources), particularly for peak or worst case scenarios. This is a significant advantage over existing solutions, which describe at most one level of QoS for a flow (e.g., an SCS flow). The signaling techniques discuss herein can then be used to quickly switch between those tiers or profiles which improves resource allocation (e.g., bandwidth allocation) in the wireless network. For example, the embodiments herein prevent allocating more resources to a STA than it needs, which means those resources are available for use by other STAs. This improves overall throughput in the wireless network.

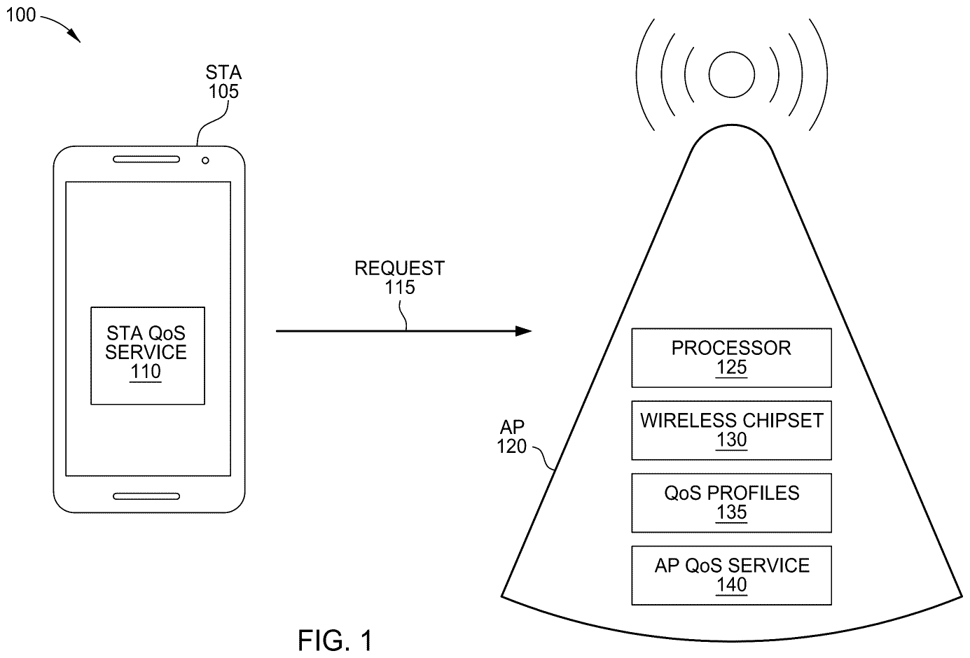

FIG. 1 is a wireless network where a STA 105 (or AP 120) can change between QoS profiles 135, according to one embodiment. While the embodiments herein specifically discuss switching between QoS profiles 135, the switching techniques described herein can also include switching between quality tiers.

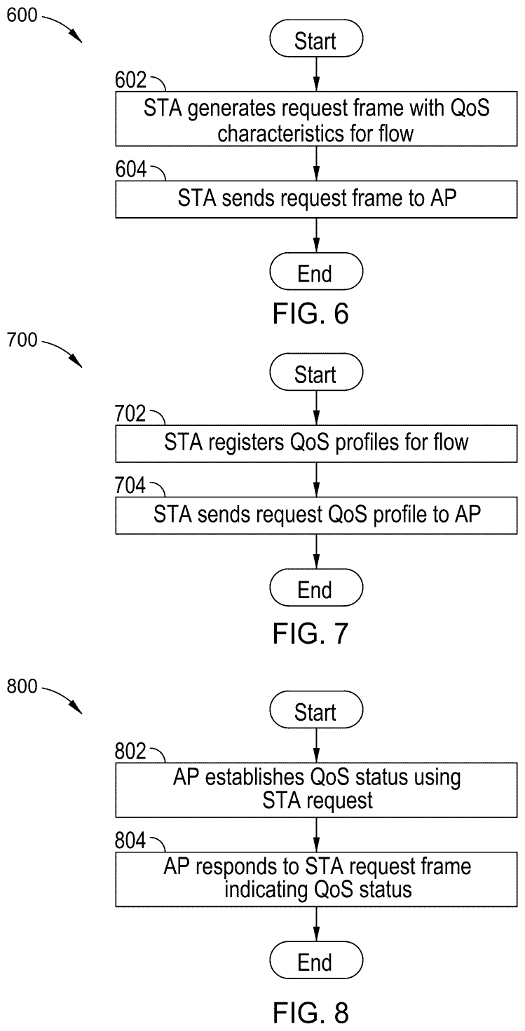

The STA 105 (e.g., a client device such as a mobile phone, laptop, desktop, tablet, etc.) includes a STA QoS service 110 that facilitates stream classification with multiple QoS profiles 135. That is, the STA QoS service 110 can communicate with an AP QoS service 140 in the AP 120 to establish the QoS profiles 135. For example, the STA QoS service 110 can generate a request frame with QoS characteristics for the different QoS profiles 135 for a flow, and send the request frame to the AP 120. In one embodiment, SCS is used to define the QoS profiles. IEEE 802.11be introduced SCS QoS Characteristics (QC) IE to allow the AP to more precisely schedule the resources allocated to a STA based on the SLA (delay, jitter, period, loss, etc.) of the application flow (e.g. video, VR, etc.). This signaling has been enhanced in many contributions for Enterprise use-cases such as end-to-end (E2E) service level agreements (SLA) and pre-arranged QoS profiles covering many possible STA bandwidth usage scenarios. The details regarding establish the QoS profiles 135 (or quality tiers) will be described below in FIGS. 6 and 7.

After the QoS profiles 135 are established, the STA 105 can send a request 115 to switch from its current QoS profile 135 to a different QoS profile 135. For example, the STA 105 may execute a teleconference application where the bandwidths requirements have increased (e.g., the user turns on a camera). Since the bandwidth used by the STA 105 has increased, the STA QoS service 105 can request that the AP switch to a QoS profile 135 that guarantees more bandwidth for the STA 105 in the wireless network 100 (e.g., a Wi-Fi network).

However, SCS signaling was designed for telephony-style flows with long term stable traffic characteristics such as MAC Service Data Unit (MSDU) size, burst length and service interval/period (or at least minimal compliance to such). SCS signaling works well for stationary applications where the achievable data-rates are stable and thus the media coding (e.g. 8K, 4K, 1K, etc.) is correspondingly stable. However, SCS signaling is not efficient for dynamic applications where (a) the data rata fluctuates (e.g. mobile app) or (b) the content type changes frequently (e.g. teleconference viewer becomes the presenter and is now the source of 8K video, or hundreds of supplemental video feeds to choose from and select based on speaker status, etc.).

While switching between QoS profiles 135 helps, SCS signaling operates at the high MAC level with STA-AP messaging effectively flowing to the hostapd on the AP (a user-space daemon for creating and managing wireless access points (APs) which then re-programs the MAC layer schedule via application programming interfaces (APIs). This process does not scale well (e.g., where there can be thousands of SCS flows being handled by the AP 120) in media adaption time-frames (a few client-server round-trips or 100 s of ms) since that represents a worst-case of thousands of SCS transactions per second.

One problem is the processing for SCS QoS Characteristics typically occurs based on a user-space to user-space 802.11 Action frame messaging architecture (i.e. in a host CPU of the AP, such as the processor 125) since the assumption is that the network or application space entities may wish to alter the negotiated contract between the AP 120 and STA 105. While this is possible, most Enterprise implementations are interested in authorizing the flow (e.g. security, QoS class, policy, etc.) and less so about the instantaneous resource requirements for that flow (e.g. 100 vs 200 kb/s, 100 vs. 25 ms, etc.). However, to prevent abuse, network system administrators may want to limit the maximum guaranteed resources consumed by any given STA or application. The SCS QC can be broken down by enforcement points and frequency of use in the Wi-Fi stack (below) to illustrate the following:
Traffic classification (TCLAS) (UL/DL) flow classifier—Layer 3 (deep packet inspection (DPI)/host), one time per new or changed SCS request (e.g. beginning of a teleconference call)
TCLAS traffic identifier (TID) mapping—Layer 3/2 interface (host), as above
Service Interval (SI)—lower MAC trigger scheduler (chipset firmware (FW)), a pre-known range based on set of codecs available (e.g. 60 Hz or 120 Hz video).
Delay Bound—partly layer 2 queue (e.g. early discard) and partly lower MAC (Wi-Fi chip's FW), based on specific coding rate and service goals
Minimum bandwidth (BW)—same as above (i.e. rate limiting) (e.g., 8K vs 1K video are quite different)
MSDU size/burst-size—low-level per-flow buffer allocation (layer 2 and chipset FW), as per above
MSDU reliability—MCS and retry selection (low MAC in chipset FW), as per above

Some of these listed functions are realized by the host CPU exclusively (e.g., the processor 125), both the host CPU and the 802.11 chipset FW (or micro-code) in a wireless chipset 130, and some by only the chipset 130. For example, the changes to the TCLAS UL/DL flow classifier and TCLAS TID mapping are handled by the host CPU (e.g., the processor 125), while changes to the remaining QoS parameters can be handled by a wireless chipset 130. As a result, changes to TCLAS UL/DL flow classifier and TCLAS TID mapping can take seconds to complete, while changes to the remaining listed QoS parameters can take milliseconds to complete (e.g., the change can be ready for the next TxOP).

A design of SCS proposed herein defines at least two (or three) messaging levels—the first level (for host CPU-only functions) can use the host-to-host Action frame as per IEEE 802.11be and use SCS Change/Modify exchanges to dynamically change the QoS/SLA (e.g. flow endpoint or class change). However, for per TxOP level changes using the first level results in excess overhead due to many SCS Change/Modify exchanges, which may not be desirable. Instead, the second level (e.g., a combination of the processor 125 and wireless chipset 130) uses the SCS Request/Change/Modify to establish upper/lower bounds on the flow characteristics (e.g. max BW, lowest delay). (In one embodiment, this second level could be clubbed with the first level for design simplicity). The third level (e.g., the chipset 130 and related QoS scheduling functions) can include a new form of IEEE 802.11 high throughput (HT)/QoS control-field based SCS QoS signaling that allows dynamic and fast switches between QoS profiles in each TXOP within pre-established bounds. Note, that this is compatible with using the QoS profiles 135 when one of the profiles 135 in the SCS Request is designated as the LIMITING profile, or with the use of an authorized set of QoS profiles which can be used for dynamically changing QoS. The LIMIT parameters (e.g. by selecting the worst-case QoS profile 135) or the set of QoS profiles 135 can be authorized during the SCS Request/Change messaging process by the host CPU. Afterwards, the changes to the SCS QC that fall within these authorized limits, or set of QoS profiles 135, can be processed immediately by the chipset 130 (then later by the host) when signaled in an HT/QoS-ctrl field.

Stated differently, the embodiments herein describe switching between the QoS profiles 135 without involving the hostapd executing on a processor 125 (e.g., host CPU) of the AP 120. The embodiments can avoid using SCS signaling such as SCS Request/Change/Modify to switch between the QoS profiles 135, which rely on the processor 125.

In one embodiment, the request 115 is included in a data frame or a control frame, which is processed by the wireless chipset 130 rather than the processor 125. This is in contrast to using a management frame to signal the request 115, which is typically used when performing a SCS Request/Change/Modify. As such, signaling the request 115 is in-band signaling since the request 115 can be placed in a data frame or control frame that would otherwise be transmitted from the STA 105 to the AP 120, rather than in its own frame such as a management frame. Transmitting the request 115 using in-band signaling does not have additional latency.

In one embodiment, the request 115 for dynamically signaling changes to a QoS profile is indicated in a MAC header of a data frame using a high efficiency (HE) A-Control field. A possible encoding of the HE A-Control field is to allocate a new Control ID to indicate dynamic QoS profile selection, followed by a Control Information field with a length of, e.g., 10-12 bits, which is made up of an 8-bit SCS ID (to identify the flow, in conjunction with the transmitter address (TA), sent in the frame) then a 2-4 bit selector for the QoS profile ID (or quality tier ID) which signals the new QoS profile (or new quality tier) that should be selected for the flow (i.e., select the codec compression level for the audio/video/etc.). In another embodiment, the request 115 for dynamically signaling changes to a QoS profile is indicated in a MAC header of a management frame also using an A-Control field. Management frames include high-throughput (HT) control in their headers, and hence A-Control Fields. As such, the request 115 can be indicated in a non-Frame body portion of a management frame, such as A-Control fields.

If the request 115 is included in a control frame, the control frame could be an acknowledgement (ACK) frame or a trigger frame. The request 115 could be part of a control frame that is a response from the STA to the AP. In another example, the request 115 could be part of a multi-STA block ACK frame, which has additional flexibility so that new fields can be added without causing compatibility issues with legacy devices. In any case, like data frames, control frames are processed much faster than management frames.

The processor 125 can represent any number of processing elements (e.g., one or more host CPUs) with any number of processor cores. The wireless chipset 130 (e.g., a Wi-Fi chipset) is a piece of hardware, often a small integrated circuit that enables the AP 120 to transmit and receive wireless signals. The wireless chipset 130 can include firmware that performs many of the functions described herein. In one embodiment, the wireless chipset 130 includes a processor that serves as a co-processor to the processor 125. The processor 125 and the wireless chipset 130 can be on separate integrated circuits.

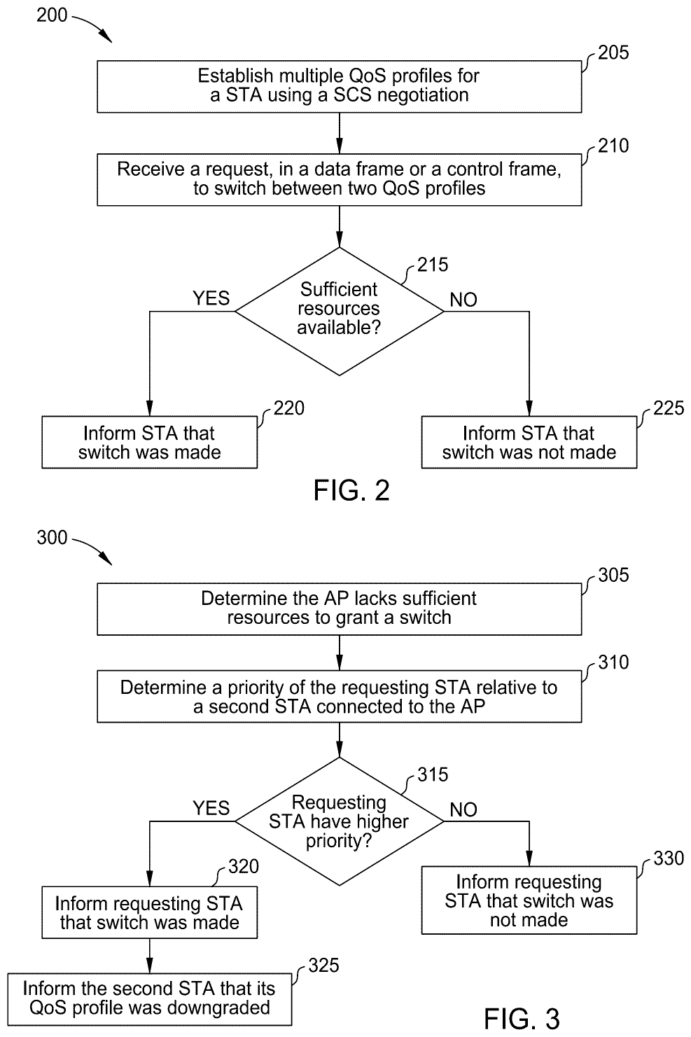

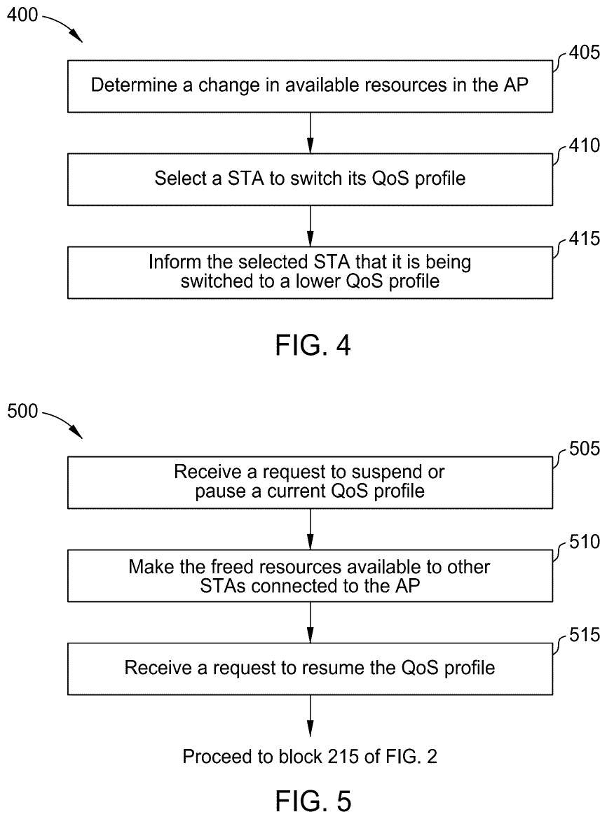

FIG. 2 is a flowchart of a method 200 for determining whether a STA can switch between QoS profiles, according to one embodiment. While the method 200 discusses switching between QoS profiles, it can also be used to switch between quality tiers.

At block 205, the STA and AP QoS services (e.g., the services 110 and 140 in FIG. 1) establish multiple QoS profiles for a flow using SCS negotiation. For example, the QoS profiles can correspond to different codec rates (e.g., 1 k, 4 k, high definition, etc.). The STA QoS service can transmit the QoS parameters (e.g., SI, delay bound, minimum BW, MSDU size, MSDU reliability, etc.) for these profiles to the AP QoS service for approval. In other examples, the AP QoS service may suggest (or use) default QoS profiles rather than having the STA provide the QoS parameters for the QoS profiles. Additional details regarding establishing the QoS profiles (or the quality tiers) using SCS negotiation are provided in FIGS. 6 and 7 below.

At block 210, the AP receives a request, in a data frame or a control frame, to switch between two QoS profiles for a STA. As discussed above, using a data frame and a control frame means the request can be processed in the wireless chipset (e.g., the chipset 130 in FIG. 1) rather than a host CPU (e.g., the processor 125 in FIG. 1) in the AP. That is, the STA uses in-band (or in-frame) communication to convey the request to the AP. The QoS parameters in the QoS profiles may be the type that can be changed by the wireless chipset without relying on the host CPU, such as SI, delay bound, minimum BW, MSDU size, MSDU reliability, etc. If the STA wants to change other types of QoS parameters such as TCLAS UL/DL flow classifier and TCLAS TID mapping, then the STA may use typical SCS signaling which relies on management frames.

As discussed above, the request to change QoS profiles may be made in a HE A-control field in a MAC header of a data frame. In another embodiment, the request may be made in an ACK frame or a trigger frame, which are examples of control frames. For example, the request may be in a multi-STA block ACK frame. However, the embodiments herein are not limited to using any particular field or IE in a data frame or control frame. So long as the request is embedded in a data frame or a control frame, the request will be processed faster than a request to change a QoS profile that is in a management frame as is typically done during SCS negotiations (e.g., SCS Change/Modify exchanges).

In one embodiment, the data frame or control frame includes a SCS flow ID to identify a particular flow (since a STA may establish multiple SCS flows to the AP) and a QoS profile ID which indicates the new, desired QoS profile of the identified SCS flow.

At block 215, the AP QoS service determines whether the AP has sufficient resource available to satisfy the new, desired QoS profile. If the STA is requesting to use a QoS profile with less demanding BW requirements (e.g., moving from a QoS profile corresponding to the 4 k codec to a QoS profile corresponding to the 1 k codec), then the answer to the query at block 215 will be yes.

One example is a teleconference application with a dynamic codec that seeks to maximize the video coding level without ever receiving best-effort service from the AP (i.e., the SCS QC requirements are always met). For example, its typical codec interval may be 35 ms with a max coding rate of 40 Mb/s with a 25 ms minimum delay constraint (based on expected E2E delay to the teleconference server). These limits may be set in the opening SCS Request where the flow spec and four QoS profiles are exchanged with the AP including two rates with nominal delay and two rates with reduced/contingent latency. The AP validates the flow as well as the limits (i.e. 40 Mb/s reduced latency QoS profile) and returns a successful SCS Response. The teleconference device starts using the best codec (40 Mb/s) based on the user activity and available high modulation coding scheme (MCS) (data rate) and the AP schedules the uplink triggers (using the wireless chipset FW) based on that rate and selects an internal queue based on the (downlink) delay bound.

During operation, however, the teleconference server may encounter unexpected intermittent Internet delays and decides to down rate one codec level (40 to 10 Mb/s) and simultaneously ask for a delay boost (25 ms->10 ms) to help the E2E delay. In one embodiment, this desire to switch QoS profiles is signaled in the 802.11 HE variant A-Control field in the MAC header (in the HT Control field) by selecting an alternate QoS profile ID for the low-rate contingent latency profile. This request immediately (in frame processing by chipset micro-code) (a) informs the UL triggering scheduler to reduce the resources guaranteed in the very next UL trigger based (TB) orthogonal frequency-division multiple access (OFDMA) TXOP, (b) informs the chipset FW flow-to-queue mapper to re-map the STA's TID to a less congested (lower delay) queue, and (c) signals the AP host of the QoS QC changes such that the SCS state is synced at the MAC control-plane level. Because this is a request to move from a high-rate to a low-rate QoS profile, the request will be granted (e.g., the wireless chipset may not have to check if the AP has sufficient resources to support the switch).

However, if the STA wants to use a QoS profile with more demanding BW requirements (e.g., use a larger MSDU burst size, a shorter delay bound, greater MSDU reliability, etc.), the wireless chipset first checks to ensure the AP has sufficient resources available to guarantee the QoS parameters associated with the new QoS profile.

If the wireless chipset determines the AP does have sufficient resources, the method 200 proceeds to block 220 where the AP starts operating using the new QoS profile and informs the STA that the switch to the new profile was made. In one embodiment, because this switch was made by the wireless chipset, the QoS parameters for the new QoS profile can be provided to the STA in the next one or more transmit opportunities (TxOps). In one embodiment, a UL triggering scheduler can update the resources guaranteed in the very next UL TB OFDMA TXOP.

In addition to informing the STA of the switch, the wireless chipset can also inform the host CPU (e.g., the main processor) in the AP that the wireless device has switched to a different QoS profile. That is, while the wireless chipset does not have to wait on the host CPU before it switches profiles, in this embodiment, the chipset still informs the host CPU in the AP of the switch.

If the wireless chipset determines the AP does not have sufficient resources for the new QoS profile, the method 200 instead proceeds to block 225 where the AP informs the STA that the switch was not made. For example, the wireless chipset can track or monitor the BW being guaranteed to each STA (or SCS flow). If switching to the new QoS profile would exceed the compute resources in the AP to meet the QoS parameters for each flow, the wireless chipset does not permit the STA to switch to the new QoS profile. In that case, the AP can continue to use the current QoS profile for servicing the STA.

However, some STAs may be “greedy” in that they always request the QoS profile that provides them with the most BW, even when those STAs do not currently need that BW. This means STAs that are not greedy may be denied using their higher-BW QoS profiles when they actually need the BW. One solution to this problem is discussed next.

FIG. 3 is a flowchart of a method 300 for using priority to determine whether to honor a request to switch between QoS profiles, according to one embodiment. The method 300 assumes that blocks 205 and 210 have already been performed where a STA is attempting to switch to a different QoS profile. Moreover, the method 300 assumes that the STA is attempting to switch to a higher performance QoS profile that provides additional BW to the STA.

At block 305, the wireless chipset in the AP determines the AP lacks sufficient resources to grant a switch to the request QoS profile. However, instead of simply denying the request to switch, the method 300 instead proceeds to block 310 where the wireless chipset determines a priority of the requesting STA relative to a second STA connected to the AP. While the method 300 discusses comparing the requesting STA to a second STA, the AP can consider the priority of every STA (or every flow) connected to the AP.

At block 315, the chipset determines whether the requesting STA has a higher priority than the second STA. For example, the second STA may be a “greedy” STA that is known to request more BW than it actually needs. Or the second STA may be an IoT device or environmental sensor that typically does not need as much bandwidth as a client device, and thus, is a lower priority device. Or the requesting STA may be company device (e.g., a company laptop) which the second STA is an employee's personal device (e.g., an employee's personal mobile phone). The company device may be assigned a higher priority than personal devices.

If the requesting STA has a higher priority, the method 300 proceeds to block 320 where the AP informs the requesting STA that the switch has been made and to block 325 where the AP informs the second STA that its QoS profile has been downgraded. That is, because the requesting STA has a higher priority, the AP switches the second STA to a lower performance QoS profile to free enough resources in the AP so the AP can switch the requesting STA to the higher performance QoS profile. In other words, the AP switches the second STA to a lower-performance QoS profile so the AP has sufficient resources to grant the switch requested by the higher priority requesting STA.

In one embodiment, the AP may downgrade the QoS profiles for multiple STAs (or multiple flows) to free sufficient resources for the requesting STA to switch to a higher performance QoS profile. For example, to free sufficient resources for the requesting STA, the AP may have to downgrade the second STA from its highest performance QoS profile to its lowest performance QoS profile. However, to lessen the impact on the second AP, the AP may identify multiple STAs with lower priorities than the requesting AP and downgrade their QoS profiles from the highest performance QoS profiles to a middle-performance QoS profile so that no one STA has a very large drop in performance.

However, if at block 315 the wireless chipset determines that no other STA (or flows) have a lower priority than the requesting STA, then the method 300 proceeds to block 330 where the AP informs the requesting STA that the switch was not made. In that case, the AP can keep serving the STA using the current QoS profile.

FIG. 4 is a flowchart of a method 400 for an AP to change QoS profiles, according to one embodiment. While FIGS. 2 and 3 discussed a STA initiating a request to change a QoS profile, method 400 illustrates that an AP can decide, on its own, to change a QoS profile.

At block 405, the AP determines a change in available resources. For example, the AP may be going through an upgrade, which may affect the amount of resources it has available. Or the AP may have detected a significant number of new STAs trying to associate to the AP, and even before these STA go through the SCS negotiation, may wish to free up additional resources for these STAs. In any case, the AP can decide on its own to switch one or more STAs to a different QoS profile.

At block 410, the AP selects a STA to change its QoS profile. For example, the AP may select a STA based on its priority (e.g., start with a lower priority STA). Or the AP may select a STA based on its current QoS profile (e.g., if the STA is currently using a high-performance QoS profile). The AP may also consider the amount of time a STA has been at the current QoS profile, or a mix of all these factors. For example, the AP may first identify the STAs that are using the highest-performance QoS profile and then filter based on their priority and how long the STAs have been using the highest-performance QoS profile to select the STA that will have its QoS profile downgraded.

At block 415, the AP informs the selected STA that it is being switched to a lower QoS profile. Like above, this new QoS profile can go into effect in the next TxOp. In this manner, the AP can switch the QoS profile of a STA without first receiving a request from a STA.

In one embodiment, the AP can tell the selected STA which QoS profiles it does currently support, so the STA can select which profile it prefers by sending a response to the AP. This gives the STA flexibility to choose its downgraded QoS profile rather than the AP choosing for the STA. Later, when the AP has sufficient resources to support one of the QoS profiles that it previously did not support, the AP can signal the STA to let it know it now has the option to switch to that QoS profile.

FIG. 5 is a flowchart of a method 500 for pausing or suspending a QoS profile, according to one embodiment. At block 505, the AP receives a request to suspend or pause a current QoS profile. For some applications there may be periods of time where SCS QoS requirements are not needed. For example, a robot may have stringent latency/jitter when performing precise operation but at other times can tolerate higher latency and jitter and best effort traffic treatment. In such cases, the robot can transmit a pause/suspend SCS+QC request for some period of time.

In one embodiment, the HE A-Control field defined for dynamic QoS changes can be used to signal suspending QoS requirements for an SCS flow in-band in data frames. One possible way is to use the SCS ID plus one of the QoS profile IDs to signal no QoS requirement for that SCS ID. Another possible approach is to use the SCS ID plus a bit to signal suspending/pausing the SCS QC for that flow.

The method 500 can be used in situations where the STA has not established multiple QoS profiles (or multiple quality tiers). That is, the STA may have only one QoS profile and then use the request to suspend or pause its profile so this BW can be used by other flows in the AP.

At block 510, the AP makes the freed resources available to other STAs connected to the AP. For example, if another STA requests a higher performance QoS profile while the QoS profile is suspended or paused, the wireless chipset can use the freed resources when determining whether the AP has sufficient resources available.

In another example, if the AP had to deny a past request from a STA to switch to a higher performance QoS profile, but the AP now has sufficient resources given the newly freed resources, the AP can inform the STA its request has now been granted. That is, the AP can retroactively grant requests for higher performance QoS profiles when freed resources become available.

At block 515, the AP receives a request to resume the QoS profile from the STA. The A-Control field can also be used to dynamically resume SCS+QC for an SCS flow using a QoS profile ID or by indicating a “resume” SCS+QC operation in the A-Control field.

While the method 500 can be performed using a data or control frame for quick response, it can also be performed using a management frame (e.g., using a SCS change/modify). This may take more time than using the data or control frame, but pausing and resuming SCS may not be a time sensitive operation.

The method 500 can then proceed to block 215 of FIG. 2 where the wireless chipset determines whether the AP has sufficient resources to resume the QoS profile. If not, the request may be denied, or the AP may downgrade one or more other STAs that have a lower priority as discussed in FIG. 3.

FIG. 6 is a flowchart of a method 600 illustrating proposing QoS characteristics for a flow as part of stream classification with multiple quality tiers, according to one embodiment. FIG. 6 is one embodiment for using SCS negotiation to establish multiple quality tiers or QoS profiles.

At block 602 an STA QoS service (e.g., the STA QoS service 110 illustrated in FIG. 1) generates a request frame (e.g., an SCS with QoS characteristics for a flow (e.g., an SCS flow)).

In an embodiment, the STA QoS service generates a request frame (e.g., an SCS request frame) with a descriptor (e.g., one or more SCS descriptors) that describes the QoS characteristics of suitable quality tiers (e.g., preferred quality tiers, all available quality tiers, or any other collection of one or more quality tiers). For example, the STA QoS service can assign each quality tier a tier identifier (e.g., for use in subsequent signaling). The STA QoS service can further indicate the STA's relative preference for each tier in the descriptor. For example, the STA QoS service can indicate an order of preference, desirability or undesirability of a particular tier (e.g., as a value, a field (e.g., a 2, 4, or 8 bit field) or using any other suitable technique), or any other relative preference.

Further, in an embodiment, the STA QoS service can indicate whether a given quality tier is required (e.g., a “hard” service level agreement (SLA)) or desired (e.g., a “soft” SLA). For example, the STA QoS service can indicate a hard-SLA-only requirement, meaning the receiving AP should either accommodate the requested QoS tier (e.g., the requested level of service reflected by the QoS characteristics for that tier) or reject the request.

As another example, the STA QoS service can indicate a hard-SLA-else-soft-SLA requirement. In this circumstance, the AP should attempt to accommodate the hard SLA tier level. If that is not available, the AP may accommodate the soft SLA tier level. But if that soft SLA tier level is not available, the AP should reject the request. As a third example, the STA QoS service can indicate a hard-SLA-else-soft-SLA-else-no-SLA. In this circumstance, the AP should first attempt to accommodate the hard SLA tier level, and if that is not available should attempt to accommodate the soft SLA tier level. But if neither is available, the AP may accept the request with no SLA tier level (e.g., as opposed to a hard-SLA-else-soft-SLA requirement in which the AP must accommodate either the hard or soft SLA QoS tier, or reject the request).

In an embodiment, the SLA type can be orthogonal to the quality level and requested separately via its own element, or can be combined with the quality level. For example, if the SLA type request is combined with the quality level, then the SLA type request can be added to each descriptor (e.g., as a subfield in a QoS characteristics element). This allows for multiple sub-elements describing different quality tiers, along with SLA preferences.

A concrete example may be useful to help explain. For example, the STA QoS service can generate a request frame that indicates any of the following:
1. SCS-level parameters for a high QoS (e.g., to support a 4K video flow) with hard SLA; else
2. SCS-level parameters for a middle QoS (e.g., to support a 2K video flow) with hard SLA; else
3. SCS-level parameters for a lower QoS (e.g., to support a 1K video flow) with hard SLA; else
4. SCS-level parameters for a high QoS (e.g., to support a 4K video flow) with hard SLA if possible and otherwise soft SLA; else
5. SCS-level parameters for a middle QoS (e.g., to support a 2K video flow) with hard SLA if possible and otherwise soft SLA; else
6. SCS-level parameters for a lower QoS (e.g., to support a 1K video flow) with hard SLA if possible and otherwise soft SLA; else
7. SCS-level parameters for a high QoS (e.g., to support a 4K video flow) with hard SLA if possible and otherwise soft SLA if possible and otherwise no SLA; else
8. SCS-level parameters for a middle QoS (e.g., to support a 2K video flow) with hard SLA if possible and otherwise soft SLA if possible and otherwise no SLA; else
9. SCS-level parameters for a lower QoS (e.g., to support a 1K video flow) with hard SLA if possible and otherwise soft SLA if possible and otherwise no SLA. These are merely examples, and the STA QoS service can generate any suitable request frame.

At block 604, the STA QoS service sends the request frame to the AP. For example, the STA QoS service can send an SCS request frame (e.g., including suitable SCS descriptors as described above) to an associated AP. This is merely an example, and the STA QoS service can send the request frame to any suitable network component (e.g., a wireless local area network (WLAN) controller (WLC), another suitable controller, or any other suitable component).

FIG. 7 is a flowchart of a method 700 further illustrating proposing QoS characteristics for a flow as part of stream classification with multiple QoS profiles, according to one embodiment. In an embodiment, FIG. 7 illustrates another technique, e.g., in addition to, or instead of, for using SCS negotiation to establish multiple quality tiers or QoS profiles.

At block 702, an STA QoS service (e.g., the STA QoS service 110 illustrated in FIG. 1) registers QoS profiles for a flow (e.g., an SCS flow).

In an embodiment, the STA QoS service registers multiple QoS profiles for a given application flow (e.g., with the AP or any other suitable network component). For example, the STA QoS service can transmit a single SCS request frame that includes a separate descriptor (e.g., a separate QoS characteristics element) for each QoS profile for the same SCS ID.

As one example, if a video streaming application supports multiple video resolutions (e.g., 8K, 4K, 2K and 1K), the STA QoS service can register four QoS profiles for that application flow by including four QoS characteristics elements for the same SCS ID (and traffic classification (TCLAS) or fully qualified domain name (FQDN), if included). Each QoS characteristics element can specify QoS characteristics for the corresponding profile (e.g., a minimum data rate requirement, other traffic characteristics, or any other suitable QoS characteristics). In an embodiment, an SCS descriptor element can include more than one QoS characteristics elements, to support registering multiple profiles.

Further, each QoS profile for a given stream (e.g., a given SCS stream or SCS ID) can be identified by a suitable identifier (e.g., a QoS profile ID). In an embodiment, the STA QoS service also indicates an initial QoS profile (e.g., an initial desired QoS profile). For example, if a video streaming application wants to activate a profile to support 2K video, out of four possible profiles, the STA QoS can indicate that as the desired profile in the request (e.g., SCS request).

At block 704, the STA QoS service sends the requested QoS profile to the AP. For example, the STA QoS service can send an SCS request frame (e.g., including suitable SCS descriptors as described above) to an associated AP. This is merely an example, and the STA QoS service can send the request frame to any suitable network component (e.g., a WLC, another suitable controller, or any other suitable component).

FIG. 8 is a flowchart of a method 800 illustrating establishing QoS characteristics for a flow as part of stream classification with multiple quality tiers, according to one embodiment. At block 802, an AP QoS service (e.g., the AP QoS service 140 illustrated in FIG. 1) establishes a QoS status using the STA request (e.g., discussed above in relation to FIGS. 6-7).

In one embodiment, the AP QoS service applies its admission control policy (if such a policy exists) and accepts or denies one tier (e.g., identified by its tier ID) from a requested SCS descriptor that includes multiple quality tiers (e.g., quality and SLA tiers, as discussed above in relation to block 602 illustrated in FIG. 6). Alternatively, or in addition, the AP QoS service records all the quality (or quality and SLA) tiers. The AP QoS service can then apply its admission control policy (again, assuming one exists), and accepts a particular tier (e.g., identified by Tier ID) or rejects all the tiers.

At block 804 the AP QoS service responds to the STA request frame indicating the QoS status. In an embodiment, the AP QoS service transmits a status frame (e.g., an SCS status frame) to the STA. For example, a typical SCS status duple is 3 octets long, including an SCS ID and two octets of status information. But the acceptance of a specific quality tier requires more information per SCS ID. This can be implemented using any of a number of suitable techniques. For example, a new frame could be defined to provide the additional information. Alternatively, the existing SCS status frame could be used, with a special continuation, or overlength, SCS ID defined (e.g., 255 or all 1s). This special SCS ID could be used to indicate that the response includes additional octets (e.g., in groups of three plus three) and indicates a response spanning 3+3 octets.

Thus, an SCS status frame could include: actual-SCS-ID (1 octet)+status-code (2 octets)+continuation/overlength-indicator (e.g., SCS ID=255) (1 octet)+tier-ID (of selected quality tier)+reserved bits (2 octets). This is merely an example, and any suitable order, sizing, and sub-ordering could be used.

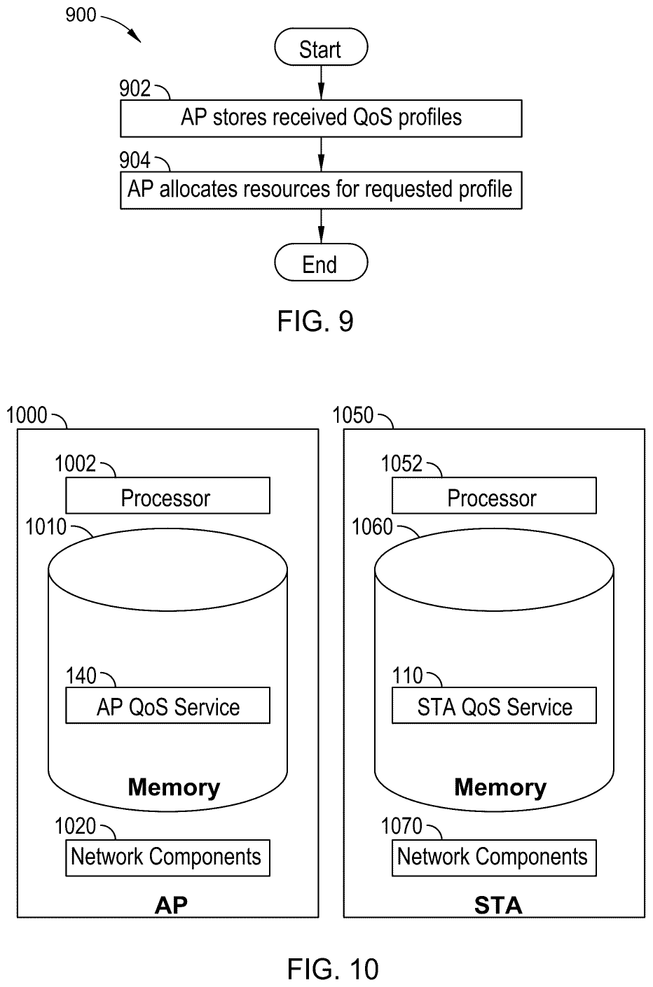

FIG. 9 is a flowchart of a method 900 further illustrating establishing QoS characteristics for a flow as part of stream classification with multiple QoS profiles, according to one embodiment. At block 902, an AP QoS service (e.g., the AP QoS service 140 illustrated in FIG. 1) stores received QoS profiles. In an embodiment, when an AP receives an SCS request which indicates multiple QoS profiles for an application flow, the AP QoS service maintains those received QoS profiles for the flow. The AP QoS service can maintain those profiles in any suitable location, including local storage or any suitable remote storage location.

At block 904, the AP QoS service allocates resources for the requested profile. In an embodiment, the AP QoS service can allocate resources for the flow based on the QoS profile signaled for activation for a given SCS stream. These resources can later be modified by switching profiles, as discussed above in FIGS. 2-4.

FIG. 10 illustrates a STA and AP, according to one embodiment. In an embodiment, the AP 1000 can correspond with the AP 120 illustrated in FIG. 1, and the STA 1050 can correspond with the STA 105 illustrated in FIG. 1.

The AP 1000 includes a processor 1002, a memory 1010, and network components 1020. The processor 1002 generally retrieves and executes programming instructions stored in the memory 1010. The processor 1002 is representative of a single central processing unit (CPU), multiple CPUs, a single CPU having multiple processing cores, graphics processing units (GPUs) having multiple execution paths, and the like. The processor 1002 can represent the processor 125 in FIG. 1 (e.g., a host CPU).

The network components 1020 include the components necessary for the AP to interface with a communication network, as discussed above in relation to FIG. 1. For example, the network components 1020 can include wired, WiFi, or cellular network interface components and associated software. In one embodiment, the network components 1020 include the wireless chipset 130 in FIG. 1. Although the memory 1010 is shown as a single entity, the memory 1010 may include one or more memory devices having blocks of memory associated with physical addresses, such as random access memory (RAM), read only memory (ROM), flash memory, or other types of volatile and/or non-volatile memory.

The memory 1010 generally includes program code for performing various functions related to use of the AP 1000. The program code is generally described as various functional “applications” or “modules” within the memory 1010, although alternate implementations may have different functions and/or combinations of functions. Within the memory 1010, the AP QoS service 140 facilitates stream classification with multiple quality tiers or QoS profiles. Further, using an AP 1000 for stream classification with multiple quality tiers or QoS profiles is merely one example. Alternatively, or in addition, any other network device (e.g., a WLC or another network component) can be used.

The STA 1050 includes a processor 1052, a memory 1060, and network components 1070. The processor 1052 generally retrieves and executes programming instructions stored in the memory 1060. The processor 1052 is representative of a single CPU, multiple CPUs, a single CPU having multiple processing cores, graphics processing units (GPUs) having multiple execution paths, and the like.

The network components 1070 include the components necessary for the STA 1050 to interface with a communication network, as discussed above in relation to FIG. 1. For example, the network components 1070 can include wired, WiFi, or cellular network interface components and associated software. Although the memory 1060 is shown as a single entity, the memory 1060 may include one or more memory devices having blocks of memory associated with physical addresses, such as random access memory (RAM), read only memory (ROM), flash memory, or other types of volatile and/or non-volatile memory.

The memory 1060 generally includes program code for performing various functions related to use of the STA 1050. The program code is generally described as various functional “applications” or “modules” within the memory 1060, although alternate implementations may have different functions and/or combinations of functions. Within the memory 1060, the STA QoS service 110 facilitates stream classification with multiple quality tiers or QoS profiles as discussed above. Further, using an STA 1050 for stream classification with multiple quality tiers or QoS profiles is merely one example. Alternatively, or in addition, any other network device (e.g., the AP 1000, a WLC or another network component, or any suitable combination) can be used.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
establishing multiple quality of service (QoS) profiles or quality tiers for a wireless device using a Stream Classification Service (SCS) negotiation between the wireless device and an access point (AP); and
receiving a request, in a data frame, a control frame, or a non-Frame body portion of a management frame, from the wireless device at the AP to switch from a first profile or tier of the established multiple QoS profiles or quality tiers to a second profile or tier of the established multiple QoS profiles or quality tiers.

2. The method of claim 1, wherein the request is received in a high efficiency (HE) A-Control field in a MAC header of the data or management frame.

3. The method of claim 2, wherein the HE A-Control field includes a SCS ID and a QoS profile ID corresponding to the second profile or tier.

4. The method of claim 1, further comprising:
determining, at a Wi-Fi chipset in the AP, that the AP has sufficient resources to satisfy requirements defined in the second profile or tier; and
altering the resources guaranteed to the wireless device, as defined in the second profile or tier, for one or more next transmit opportunities (TXOPs) for the wireless device.

5. The method of claim 4, further comprising, after determining that the AP has sufficient resources to satisfy requirements defined in the second profile or tier:
informing a host CPU in the AP, that is separate from the Wi-Fi chipset, that the wireless device has switched to the second profile or tier.

6. The method of claim 1, further comprising:
receiving a second request, in a data frame, a control frame, or a non-Frame body portion of a management frame, from the wireless device at the AP to suspend a current QoS profile or tier being used to guarantee resources to the wireless device; and
receiving a third request after the second request, in a data frame, a control frame, or a non-Frame body portion of a management frame, from the wireless device at the AP to resume the current QoS profile or tier.

7. The method of claim 1, further comprising:
determining at the AP to switch a current QoS profile or tier of the wireless device to a different one of the QoS profiles or quality tiers; and
informing the wireless device that the AP has switched to the different one of the QoS profiles or quality tiers.

8. A network device comprising:
one or more memories; and
one or more processors communicatively coupled to the one or more memories, wherein the one or more processors are configured to, individually or collectively, perform operations comprising:
establishing multiple quality of service (QoS) profiles or quality tiers for a wireless device using a Stream Classification Service (SCS) negotiation between the wireless device and the network device; and
receiving a request, in a data frame, a control frame, or a non-Frame body portion of a management frame, from the wireless device to switch from a first profile or tier of the established multiple QoS profiles or quality tiers to a second profile or tier of the established multiple QoS profiles or quality tiers.

9. The network device of claim 8, wherein the request is received in a high efficiency (HE) A-Control field in a MAC header of the data or management frame.

10. The network device of claim 9, wherein the HE A-Control field includes a SCS ID and a QoS profile ID corresponding to the second profile or tier.

11. The network device of claim 8, wherein the operations comprise:
determining, at a Wi-Fi chipset in the network device, that the network device has sufficient resources to satisfy requirements defined in the second profile or tier; and
altering the resources guaranteed to the wireless device, as defined in the second profile or tier, for one or more next transmit opportunities (TXOPs) for the wireless device.

12. The network device of claim 11, wherein the operations comprise, after determining that the network device has sufficient resources to satisfy requirements defined in the second profile or tier:
informing a host CPU in the network device, that is separate from the Wi-Fi chipset, that the wireless device has switched to the second profile or tier.

13. The network device of claim 8, wherein the operations comprise:
receiving a second request, in a data frame, a control frame, or a non-Frame body portion of a management frame, from the wireless device to suspend a current QoS profile or tier being used to guarantee resources to the wireless device; and
receiving a third request after the second request, in a data frame, a control frame, or a non-Frame body portion of a management frame, from the wireless device to resume the current QoS profile or tier.

14. The network device of claim 8, wherein the operations comprise:
determining at the network device to switch a current QoS profile or tier of the wireless device to a different one of the QoS profiles or quality tiers; and
informing the wireless device that the network device has switched to the different one of the QoS profiles or quality tiers.

15. An access point (AP) comprising:
one or more memories; and
one or more processors communicatively coupled to the one or more memories, wherein the one or more processors are configured to, individually or collectively, perform operations comprising:
providing multiple quality of service (QoS) profiles or quality tiers for a wireless device using a Stream Classification Service (SCS) negotiation; and
receiving a request, in a data frame, a control frame, or a non-Frame body portion of a management frame, from the wireless device at the AP to switch from a first profile or tier of the multiple QoS profiles or quality tiers to a second profile or tier of the multiple QoS profiles or quality tiers.

16. The AP of claim 15, wherein the request is received in a high efficiency (HE) A-Control field in a MAC header of the data or management frame.

17. The AP of claim 16, wherein the HE A-Control field includes a SCS ID and a QoS profile ID corresponding to the second profile or tier.

18. The AP of claim 15, wherein the operations comprise:
determining, at a Wi-Fi chipset in the AP, that the AP has sufficient resources to satisfy requirements defined in the second profile or tier; and
altering the resources guaranteed to the wireless device, as defined in the second profile or tier, for one or more next transmit opportunities (TXOPs) for the wireless device.

19. The AP of claim 18, wherein the operations comprise, after determining that the AP has sufficient resources to satisfy requirements defined in the second profile or tier:
informing a host CPU in the AP, that is separate from the Wi-Fi chipset, that the wireless device has switched to the second profile or tier.

20. The AP of claim 15, wherein the operations comprise:
receiving a second request, in a data frame, a control frame, or a non-Frame body portion of a management frame, from the wireless device to suspend a current QoS profile or tier being used to guarantee resources to the wireless device; and
receiving a third request after the second request, in a data frame, a control frame, or a non-Frame body portion of a management frame, from the wireless device to resume the current QoS profile or tier.
